(19) United States
(12) Patent Application Publication
(10) Pub. No.: US 2018/0346148 A1
(43) Pub. Date: Dec. 6, 2018

(54) GIMBAL AND UNMANNED AERIAL VEHICLE

(71) Applicant: AUTEL ROBOTICS CO., LTD., Shenzhen (CN)

(72) Inventor: Zhengli ZHANG, Shenzhen (CN)

(21) Appl. No.: 16/046,258

(22) Filed: Jul. 26, 2018

Related U.S. Application Data
(63) Continuation-in-part of application No. PCT/CN2016/103013, filed on Oct. 24, 2016.

(30) Foreign Application Priority Data
Jan. 26, 2016 (CN) 201620078500.1

(51) Int. Cl. B64D 47/08; G03B 17/56; G03B 15/00; B64C 39/02

(52) U.S. Cl. CPC B64D 47/08; G03B 17/561; G03B 15/006; B64C 2201/108; B64C 2201/02; B64C 2201/127; B64C 39/02

(57) ABSTRACT

The present application discloses a gimbal and an unmanned aerial vehicle. The gimbal includes a first connecting arm, a second connecting arm, a yaw axis motor, a roll axis motor, a pitch axis motor and a camera. A free end of the first connecting arm is connected to the yaw axis motor. A holding end of the first connecting arm is adjacent to the second connecting arm. Adjacent parts of the first connecting arm and the second connecting arm are connected to the roll axis motor, respectively. The two free ends of the second connecting arm are located on two sides of the camera in a embracing posture. One free end of the second connecting arm is connected to the camera, and the other free end of the second connecting arm is connected to the pitch axis motor. The pitch axis motor is further connected to the camera.

### CROSS-REFERENCE

This application is a continuation-in-part application of International Application No. PCT/CN2016/103013, filed on Oct. 24, 2016, which claims priority of Chinese Patent Application 2016200785001, filed on Jan. 26, 2016, which is incorporated herein by reference in its entirety.

### TECHNICAL FIELD

The present application relates to auxiliary appliances for shooting, and in particular, to a gimbal and an unmanned aerial vehicle.

### RELATED ART

A tri-axial gimbal generally includes three rotation shafts: a yaw axis for controlling the gimbal to rotate around the y-axis, a roll axis for controlling the gimbal to rotate around the z-axis, and a pitch axis for controlling the gimbal to rotate aound the x-axis. In general, in the prior art, the three rotation shafts are connected together by using two gimbal supports, wherein the three rotation shafts are separately connected to the supports flexibly so as to implement three-dimensional rotation of a camera. However, in the prior art, the pitch axis (which is a rotation shaft controlling a shooting pitch angle of the camera) directly connected to the camera is not only a power source for driving the camera to rotate up and down but also a supporting member for the weight of the camera. As is known according to the common sense, as the camera is connected to the one and only one shaft, the pitch axis. In case a small gap appears at the joint part between the camera and the pitch axis, the end of the camera which is not connected to the pitch axis will tilt downward, causing the center of gravity of the camera to move downward and be located below the center line of a rotor of the pitch axis. In the case the center of gravity of the camera declines, the pitch axis has to work upward to overcome the gravity of the camera when controlling the camera to rotate. This increases a total work value required for the rotation of a particular angle, causing a rotation angle of the camera to be smaller than a set rotation angle. Moreover, such a deviation will increase constantly over the service time, which cannot be eliminated by using a software-designed lead. In addition, the downward movement of the center of gravity of the camera would cause the camera to generate a small centrifugal force during rotation, leading to unstable movement of a camera lens which affects the shooting effect.

### SUMMARY

The main technical problem to be solved by the present application is to provide a gimbal. A connecting arm, which is connected to a camera, of the gimbal is provided with two free ends. The two free ends are located on two sides of the camera in a embracing posture. This structure can ensure that the center of gravity of the camera is constantly located on the center line of a rotor of a pitch axis, so that a rotation angle of the camera is smooth.

In order to solve the foregoing technical problem, one technical solution used in the present application is: providing a gimbal that includes a first connecting arm, a second connecting arm, a yaw axis motor, a roll axis motor, a pitch axis motor and a camera. A free end of the first connecting arm is connected to the yaw axis motor. A holding end of the first connecting arm is adjacent to the second connecting arm. Adjacent parts of the first connecting arm and the second connecting arm are connected to the roll axis motor, respectively. Two free ends of second connecting arm are located on two sides of the camera in a embracing posture. One free end of the second connecting arm is connected to the camera, and the other free end of the second connecting arm is connected to the pitch axis motor. The pitch axis motor is further connected to the camera.

Further, the gimbal further includes a damping support, and the damping support is connected to the yaw axis motor.

Further, the damping support includes: an upper support, a lower support and a damping device, wherein the damping device is disposed between the upper support and the lower support.

Further, the lower support is connected to the yaw axis motor through a clamping structure.

Further, the yaw axis motor, the roll axis motor, and the pitch axis motor each include a stator and a rotor. The rotor of the yaw axis motor is connected to the free end of the first connecting arm. The stator of the roll axis motor is connected to the holding end of the first connecting arm, and the rotor of the roll axis motor is connected to the second connecting arm. The stator of the pitch axis motor is connected to the free end of the second connecting arm, and the rotor of the pitch axis motor is connected to the camera.

Further, the first connecting arm and the second connecting arm are each provided with a hollow channel therein, and cables are laid in the hollow channels.

Further, the cable in the hollow channel of the first connecting arm is divided into three cables at the roll axis motor, one cable is connected to the roll axis motor, and the other two cables extend into the hollow channel of the second connecting arm.

Further, one of the cables extending into the hollow channel of the second connecting arm is connected to the pitch axis motor and the other cable is connected to the camera.

Further, the cables extending into the hollow channel of the second connecting arm are located on two sides of the camera, one cable is laid at the free end, which is connected to the pitch axis motor, of the second connecting arm and is connected to the pitch axis motor, and the other cable is laid at the other free end of the second connecting arm and is connected to the camera.

In order to solve the foregoing technical problem, the present application further provides an unmanned aerial vehicle, where the gimbal described in the foregoing technical solution is mounted in the unmanned aerial vehicle.

The present application has the following beneficial effects: In the present application, a connecting arm, which is directly connected to a camera, of the gimbal is provided with two free ends. The two free ends are located on two sides of the camera in a embracing posture. One free end is connected to the pitch axis motor, and the other free end is connected to the camera. In this technical solution, the connecting arm actually has two supporting points for the camera. The two supporting points are on the same straight line with a rotator of the pitch axis motor, ensuring that the center of gravity of the camera is constantly located on the rotor of the pitch axis motor, thereby avoiding problems of inaccurate regulation and unsmooth camera rotation caused by the fact that the pitch axis motor has to work upward to overcome the center of gravity of the camera when driving the camera to rotate.

### BRIEF DESCRIPTION OF THE DRAWINGS

FIG. 1 is a front view of a gimbal according to the present application;

FIG. 2 is a cross sectional view of a right view of a gimbal according to the present application;

FIG. 3 is a schematic view of a gimbal showing the camera connection structure thereof according to the present application; and

FIG. 4 is a exploded view of a damping support of a gimbal according to the present application.

Description of the reference numerals in the drawings: 11, first connecting arm; 12, second connecting arm; 21, yaw axis motor; 211, the stator of the yaw axis motor; 212, the rotor of the yaw axis motor; 22, roll axis motor; 221 the stator of the roll axis motor; 222, the rotor of the yaw axis motor; 23, pitch axis motor; 231, the stator of the pitch axis motor; 232, the rotor of the pitch axis motor; 24, camera; 25, shaft rod; 31, damping support; 32, upper support; 33, lower support; 34, damping device; 35, snapping opening; 41, hollow channel; 42, cable.

### DETAILED DESCRIPTION

To make the present application easier to understand, the present application is described in further detail below with reference to the accompanying drawings and specific embodiments. It should be noted that, when an element is described as being “fixed on” another element, it can be directly on another element, or one or more intermediate elements can exist between the two elements. When one element is described as being “connected to” another element, it can be directly connected to another element, or one or more intermediate elements can exist between the two elements. The terms “vertical”, “horizontal”, “left” and “right” as well as other similar expressions used in the specification are merely for the descriptive purpose.

Unless otherwise specified, meanings of all technical and scientific terms used in the specification are the same as what is generally understood by a person skilled in the technical field of the present application. The terms used in the specification of the present application are merely used for the purpose of describing the specific embodiments but are not intended to limit the present application. The term “and/or” used in the specification includes combinations of any or all of one or more associated items that are listed.

The present application is described in detail below with reference to the accompanying drawings and embodiments.

### EMBODIMENT 1

A yaw axis, a roll axis and a pitch axis are aviation terms. Taking the aircraft as an example, Yaw means to rotate around the yaw axis, wherein the yaw axis refers to a virtual axis drawn through the fuselage of the aircraft from top to bottom, parallel to the fuselage station. When the aircraft rotates around the Yaw axis, it carries out a yaw movement, that is, the aircraft, centered on the vertical line of the center of gravity of the fuselage, moves around the yaw axis to the left or right of its direction of motion, which changes the direction it is pointing. Roll means to rotate around the roll axis, wherein the roll axis refers to a virtual axis drawn through the fuselage of the aircraft from nose to tail. When the aircraft rotates around the roll axis, it carries out a roll movement, that is, the aircraft, centered on the longitudinal axis of the fuselage, roll to the left (counterclockwise) or right (clockwise) as viewed from the rear. Pitch means to rotate around the pitch axis, wherein the pitch axis refers to a virtual axis running through the fuselage of the aircraft from the left to the right. When the aircraft rotates around the pitch axis, it carries out a pitch movement, that is, the aircraft, centered on the lateral axis of the fuselage, raises the nose of the aircraft and lowers the tail, or vice versa. Directions of the yaw axis, the roll axis and the picth axis are directions defined according to the right-handed Cartesian coordinate system.

In this embodiment of the present application, installed around the yaw axis is a yaw motor, installed around the roll axis is a roll motor, and installed around the pitch axis is a pitch motor.

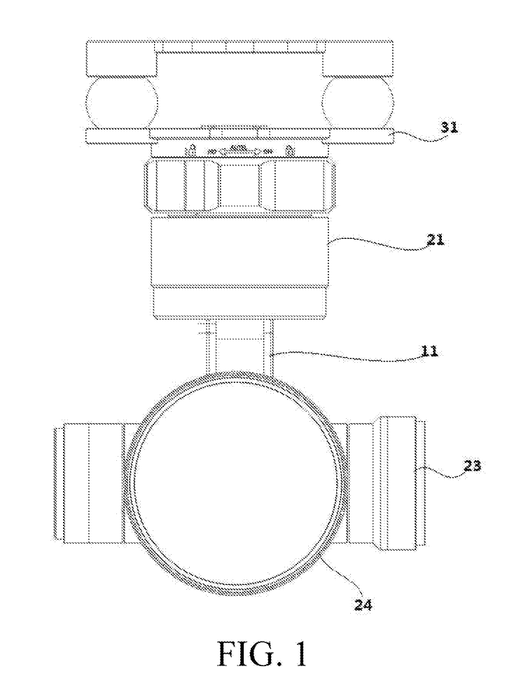

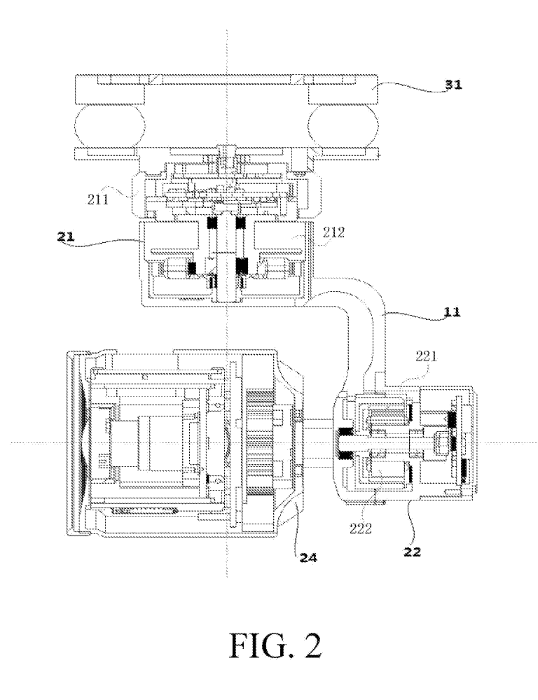

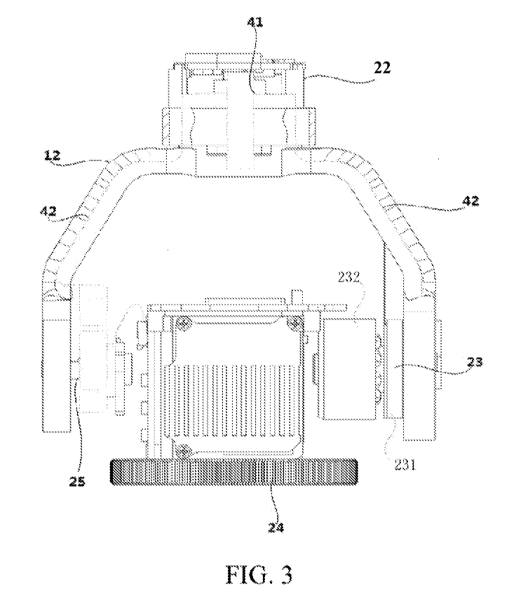

Referring to FIG. 1 to FIG. 3, a gimbal includes a first connecting arm 11, a second connecting arm 12, a yaw axis motor 21, a roll axis motor 22, a pitch axis motor 23, a camera 24, and a damping support 31. The yaw axis motor 21 is connected to the damping support 31. A free end of the first connecting arm 11 is connected to the yaw axis motor 21. A holding end of the first connecting arm 11 is adjacent to the second connecting arm 12. Adjacent parts of the first connecting arm 11 and the second connecting arm 12 are connected to the roll axis motor 22, respectively. As shown in FIG. 3, two free ends of the second connecting arm 12 are located on two sides of the camera 24 in a embracing posture. One free end of the second connecting arm 12 is connected to the camera 24, and the other free end of the second connecting arm 12 is connected to the pitch axis motor 23. The pitch axis motor 23 is further connected to the camera 24. The free end of the first connecting arm 11 is an end close to the yaw axis motor 21, and the holding end of the first connecting arm 11 is an end away from the yaw axis motor 21. The two free ends of the second connecting arm 12 are two ends away from the roll axis motor 22.

Specifically, please combine FIG. 1 and FIG. 3. The yaw axis motor 21, the roll axis motor 22 and the pitch axis motor 23 each includes a stator and a rotor. The stator 211 of the yaw axis motor 21 is connected to the damping support 31. The rotor 212 of the yaw axis motor 21 is connected to the free end of the first connecting aim 11. The stator 221 of the roll axis motor 22 is connected to the holding end of the first connecting arm 11, and the rotor 222 of the roll axis motor 22 is connected to the second connecting arm. The stator 231 of the pitch axis motor 23 is connected to the free end of the second connecting arm 12, and the rotor 232 of the pitch axis motor 23 is connected to the camera 24.

As one embodiment, the yaw axis motor 21 is connected to the damping support 31 perpendicularly. The rotor 212 of the yaw axis motor 21 is connected to the free end of the first connecting arm 11. The overall shape of the first connecting arm 11 is inverted L-shaped. The corner of the L shape transitions smoothly. The shorter arm of the L shape is the free end of the first connecting arm 11, and a hole matching the rotor 212 of the yaw axis motor 21 is provided on a side of the free end. The longer arm of the L shape is the holding end of the first connecting arm 11. The overall shape of the second connecting arm 12 of the gimbal is U-shaped. Two straight anus of the U shape are free ends of the second connecting arm 12. A middle portion of the second connecting arm 12 is close to the holding end of the first connecting arm 11, but is neither connected to nor in contact with the holding end of the first connecting arm 11. The holding end of the first connecting arm 11 is connected to the stator 221 of the roll axis motor 22. Therefore, when the yaw axis motor 21 rotates, it drives all devices disposed below the yaw axis motor 21 to rotate around the y-axis, such as the first connecting arm 11, the second connecting arm 12, the roll axis motor 22, the pitch axis motor 23 and the camera 24, etc.

The middle portion of the second connecting arm 12 is connected to the rotor 222 of the roll axis motor 22. When the roll axis motor 22 rotates, it drives the second connecting arm 12 and the camera 24 connected on the second connecting arm 12 to rotate around the z-axis.

The stator 231 of the pitch axis motor 23 is connected on one free end of the second connecting arm 12, and the free end is connected to the stator 231 of the pitch axis motor 23 perpendicularly. The rotor 232 of the pitch axis motor 23 faces the other free end of the second connecting arm 12. The rotor 232 of the pitch axis motor 23 is connected to the camera 24. A shaft rod 25 facing the camera 24 is fixed on the other free end of the second connecting arm 12. A shaft connection is realized between the shaft rod 25 and the camera 24. The shaft rod 25 and the rotor 232 of the pitch axis motor 23 are located on the same straight line. The camera 24 can conduct a pitching rotation between the two free ends of the second connecting arm 12 that is the rotation around the X axis.

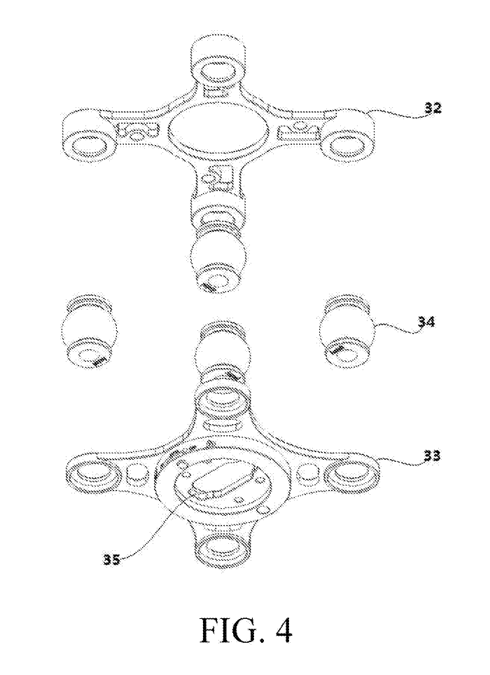

As shown in FIG. 4, combined with FIG. 1, in the solution of the present embodiment, the stator 212 of the yaw axis motor 21 is connected to the damping support 31. The damping support 31 includes an upper support 32, a lower support 33 and a damping device 34. The upper support 32 is directly connected to the unmanned aerial vehicle through a bolt. A snapping opening 35 is provided at a middle portion of the lower support 33. A clamping device (not shown in the figure) fitting the snapping opening 35 is provided on a housing of the stator 211 of the yaw axis motor 21. The damping device 34 is disposed between the upper support 32 and the lower support 33, and is used for buffering mechanical vibration generated by the unmanned aerial vehicle and the gimbal, so as to ensure shooting stability of the camera 24. Both the upper support 32 and the lower support 33 are X-shaped, and are each provided with damping devices 34 at four endpoints so as to connect the upper support 32 and the lower support 33. A circular through hole is provided at a middle portion of the upper support 32. In order to reduce the weight of the damping support 31 as much as possible, arms extended from the upper supports 32 and lower supports 33 are provided with hollow patterns. A clamping structure is connected to the stator 211 of the yaw axis motor 21, and the clamping structure is fixedly clamped in the circular through hole of the lower support 33.

In an optional embodiment of the present application, the damping device 34 may be a damping ball. The damping ball is a ball-shaped damping device 34 made of silicone, and is applicable to the field of small-sized damping. Damping balls with different damping effects can be made according to different silicone hardness. According to specific application scenarios, different damping devices 34 can also be spring dampers.

As shown in FIG. 3, in the solution of the present embodiment, the first connecting arm 11 and the second connecting arm 12 are each provided with a hollow channel 41 therein. Cables 42 are laid in the hollow channels 41. One end of the cable 42 in the hollow channel 41 of the first connecting arm 11 is connected to a control system of the unmanned aerial vehicle, and the other end is divided into three cables at the roll axis motor 22, where one cable is connected to the roll axis motor 22, and the other two cables extend into the hollow channel 41 of the second connecting arm 12. The two cables 42 extending into the hollow channel 41 of the second connecting arm 12 are semicircular at the rotation shaft of the roll axis motor 22. One end of the semicircular coil enters into the hollow channel 41 at the free end, which is connected to the pitch axis motor 23, of the second connecting arm 12, and is connected to the pitch axis motor 23. The other end enters into the hollow channel 41 at the free end connected to the shaft rod 25, and is connected to the camera 24. The cable 42 connected to the camera 24 is arranged along a planar spiral curve at the shaft rod 25. The center of the spiral cable is sleeved on the shaft rod 25, so as to prevent the cable 42 from being broken during a rotating and pulling process.

In some embodiments, the two cables extending into the hollow channel 41 of the second connecting arm 12 are distributed at the same free end. The free end is a free end to which the pitch axis motor 23 is connected, where one cable is connected to the pitch axis motor 23, and the other cable is connected to the camera 24. The cable connected to the camera 24 is wound along a spiral curve at the rotor 232 of the pitch axis motor 23.

### EMBODIMENT 2

An unmanned aerial vehicle is provided. The unmanned aerial vehicle includes the gimbal structure described in Embodiment 1.

It should be noted that although the specification of the present application and the accompanying drawings thereof have given preferred embodiments of the present application, the present application can be implemented in many different forms and is not limited to the embodiments described in the specification. The embodiments are not used as extra limit on the content of the present application. The embodiments are provided so that the disclosure of the present application can be understood more thoroughly and comprehensively. Moreover, the technical features above can be further combined with each other to form various embodiments that are not listed above, which are all considered within the disclosure range of the specification of the present application. Further, a person of ordinary skill in the art can improve or change the foregoing description, and all the improvements and changes should belong to the protection scope of the present application.

What is claimed is:

1. A gimbal, comprising a first connecting arm, a second connecting arm, a yaw axis motor, a roll axis motor, a pitch axis motor and a camera, wherein a free end of the first connecting arm is connected to the yaw axis motor, a holding end of the first connecting arm is adjacent to the second connecting arm, adjacent parts of the first connecting arm and the second connecting arm are connected to the roll axis motor, respectively, the two free ends of the second connecting arm are located on two sides of the camera in a embracing posture, one free end of the second connecting arm is connected to the camera, the other free end of the second connecting arm is connected to the pitch axis motor, and the pitch axis motor is connected to the camera.

2. The gimbal according to claim 1, wherein the gimbal further comprises a damping support, and the damping support is connected to the yaw axis motor.

3. The gimbal according to claim 2, wherein the damping support comprises: an upper support, a lower support and a damping device, wherein the damping device is disposed between the upper support and the lower support.

4. The gimbal according to claim 3, wherein the lower support is connected to the yaw axis motor through a clamping structure.

5. The gimbal according to claim 1, wherein the yaw axis motor, the roll axis motor, and the pitch axis motor each comprise a stator and a rotor;
the rotor of the yaw axis motor is connected to the free end of the first connecting arm;
the stator of the roll axis motor is connected to the holding end of the first connecting arm, and the rotor of the roll axis motor is connected to the second connecting arm; and
the stator of the pitch axis motor is connected to the free end of the second connecting arm, and the rotor of the pitch axis motor is connected to the camera.

6. The gimbal according to claim 1, wherein the first connecting arm and the second connecting arm are each provided with a hollow channel therein.

7. The gimbal according to claim 6, wherein a cable is laid in the hollow channel of the first connecting arm.

8. The gimbal according to claim 7, wherein the cable in the hollow channel of the first connecting arm is divided into three cables at the roll axis motor, one cable is connected to the roll axis motor, and the other two cables extend into the hollow channel of the second connecting arm.

9. The gimbal according to claim 8, wherein one of the cables extending into the hollow channel of the second connecting arm is connected to the pitch axis motor and the other cable is connected to the camera.

10. The gimbal according to claim 8, wherein the cables extending into the hollow channel of the second connecting arm are located on two sides of the camera, one cable is laid at the free end, which is connected to the pitch axis motor, of the second connecting arm and is connected to the pitch axis motor, and the other cable is laid at the other free end of the second connecting arm and is connected to the camera.

11. The gimbal according to claim 8, wherein the two cables extending into the hollow channel of the second connecting arm are distributed at the same free end of the second connecting arm.

12. The gimbal according to claim 11, wherein the two cables extending into the hollow channel of the second connecting arm are distributed at the end, which is connected to the pitch axis motor, of the second connecting arm.

13. An unmanned aerial vehicle, wherein the unmanned aerial vehicle includes the gimbal according to claim 1.
